(19) United States
(12) Patent Application Publication
(10) Pub. No.: US 2011/0172991 A1
(43) Pub. Date: Jul. 14, 2011

(54) SENTENCE EXTRACTING METHOD, SENTENCE EXTRACTING APPARATUS, AND NON-TRANSITORY COMPUTER READABLE RECORD MEDIUM STORING SENTENCE EXTRACTING PROGRAM

(75) Inventor: Akifumi NAKAHAMA, Nagoya (JP)

(73) Assignee: Fujitsu Limited, Kawasaki (JP)

(21) Appl. No.: 13/073,168

(22) Filed: Mar. 28, 2011

Related U.S. Application Data
(63) Continuation of application No. PCT/JP2009/005126, filed on Oct. 2, 2009.

(30) Foreign Application Priority Data
Oct. 3, 2008 (JP) 2008-258776

(51) Int. Cl. G06F 17/27

(52) U.S. Cl. 704/9

(57) ABSTRACT

A sentence similar to the sampling sentence group can be efficiently extracted from the extraction target sentence group by repeating the process of narrowing a plurality of pairs of morphemes extracted from the sampling sentence group in the order of closer number of higher similarity to the extraction target sentence including each pair of morphemes.

### CROSS-REFERENCE TO RELATED APPLICATIONS

This application is based upon and claims the benefit of priority of the prior Japanese Patent Application No. 2008-258776, filed on Oct. 3, 2008, the entire contents of which are incorporated herein by reference.

This application is a continuation of PCT application PCT/JP2009/005126, which was filed on Oct. 2, 2009.

### FIELD

The present invention relates to a method of extracting a sentence.

### BACKGROUND

Recently, business activities for improving products and services and developing new merchandise by collecting and analyzing the opinions of clients (text information) obtained through the Internet and call centers, and taking actions based on the analysis results have been widely realized and established.

However, the analysis of the “opinions of clients” is performed by repeating hypotheses and verifications, and it is necessary to collect text information to be analyzed and check the collected contents, thereby requiring quite a long time.

In addition, the checking operation can be performed only by those having sufficient knowledge of related merchandise.

For the reasons above, a number of corporations are subject to large time losses in obtaining analysis results and propagating information in the organization, which has been the problem with the timely action.

The operation of analyzing the opinions of clients includes (1) collecting object text information, and (2) checking the contents.

From the viewpoint of speeding up the analyzing operation, it is necessary to collecting object text with high accuracy. If the object text can be collected with high accuracy, the amount of contents checking can be optimized, thereby reducing the load of the analyzer and furthermore speeding up the analyzing operation.

To collect the object text, a combination of keywords for extracting the text is required.

FIG. 17 illustrates the concept of the process for extracting an inquiry corresponding to the meaning of “abnormal printing” as object text from 10,000 pieces (original data) of inquiry data at a call center in May in 2008.

A plurality of keywords are specified for 10,000 pieces of original data, thereby extracting the data including the plurality of keywords as object text. The extracted object text is utilized to generate a monthly number transition table of the inquiries corresponding to the meaning of, for example, “abnormal printing”.

In this case, the extracted contents largely depend on the specified keywords. That is, when a keyword not frequently used is included in object text, the extraction accuracy is lowered.

Therefore, the knowledge as to how a keyword is to be selected is required to improve the extraction accuracy of object text. However, the combination of keywords for collecting object text, that is, the operation of setting a grouping dictionary has conventionally depends largely on the personal skill of an analyzer.

Relating to the technique of determining a keyword, the following patent documents 1 through 3 have been disclosed.

Japanese Laid-open Patent Publication No. 2002-183194 discloses the technique of extracting a keyword from the number of occurrences of the word in a specified sentences, calculating the co-occurrence level of two keywords for all combinations, and grouping the keywords from the co-occurrence level.

Japanese Laid-open Patent Publication No. 2001-060199 discloses the technique of extracting a keyword based on the morpheme analysis of a sentence, and describing for each group the grouping rule for description of one or more combinations of a keyword and attribute information indicating the characteristics of a group.

Japanese Laid-open Patent Publication No. 2002-189754 discloses the technique of using the occurrence order of a word as the word occurrence position information about a retrieved word, and calculating the correlation between two retrieved words based on the difference in occurrence order between the two retrieved words.

However, there has been the following problems with the extraction of object text.

For example, in the conventional technique largely depending on personal operations, when the number of pieces of inquiry data increases, there is the problem that it is practically impossible to extract all object text using human eyes.

Although there is a method of narrowing inquiry data in retrieving a keyword, it is practically impossible to retrieve a “keyword” without fail for extraction of object text.

Furthermore, if a “keyword” for extraction is generated by trial and error, there occurs variance of collection accuracy by object text when there are plural pieces of object text, and it is very difficult to appropriate manage the them.

### SUMMARY

The first aspect of the present invention has the following configuration.

A plural morpheme occurrence sampling sentence storage unit associates a plurality of sampling sentence groups identified by sentence identifiers with each of a plurality of morphemes commonly occurring in the sentences of the plurality of sampling sentence groups with sentence identifiers, and stores the sampling sentence groups in a storage unit. The sampling sentence groups are determined by a user based on, for example, a similar sentence group extracted when previously extracting a similar sentence.

A plural morpheme occurrence extraction target sentence storage unit associates for each of a plurality of morphemes a plurality of extraction target sentence groups identified by sentence identifiers with identifiers of sentences commonly occurring after extracting the identifiers of the sentences, and stores the sentences in the storage unit.

A number similarity calculation unit calculates for each of the plurality of morphemes the similarity between the number of sentence identifiers of the sampling sentence groups associated with the plurality of morphemes and stored in the storage unit and the number of sentence identifiers of the extraction target sentence groups.

An extraction unit extracts the sentence identifiers of the extraction target sentence groups associated with the plurality of morphemes and stored in the storage unit in a descending order of the calculated similarity.

An exclusion unit excludes the sentence groups corresponding to the sentence identifiers other than the extracted sentence identifiers from the extraction target sentence groups.

An object sentence determination unit repeats each process of the plural morpheme occurrence sampling sentence storage unit, the number similarity calculation unit, the extraction unit, and the exclusion unit until the difference between the number of sentence identifiers extracted by the extraction unit and the number of sentence identifiers extracted immediately before by the extraction unit reaches a predetermined value, and determines the extraction target sentence groups identified by remaining sentence identifiers as object sentence groups.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration according to the first embodiment of the present invention;

FIG. 2 is a configuration according to the second embodiment of the present invention;

FIG. 3 is a flowchart (1) of the detailed operation with the configuration according to the second embodiment and input/output data;

FIG. 4 is a flowchart (2) of the detailed operation with the configuration according to the second embodiment and input/output data;

FIG. 5 is a flowchart (3) of the detailed operation with the configuration according to the second embodiment and input/output data;

FIG. 6 is an explanatory view of an example of extracted data and an example of original data;

FIG. 7A-7E is a view (1) of an example of the configuration of data in each processing step;

FIG. 8A-8D is a view (2) of an example of the configuration of data in each processing step;

FIG. 9A and 9B is a view (3) of an example of the configuration of data in each processing step;

FIG. 10A and 10B is an explanatory view of a data format of a morpheme analysis result file;

FIG. 11A and 11B is an explanatory view of a reprocessing determining process;

FIG. 12 is an explanatory view of a reprocessing operation;

FIG. 13 is an explanatory view of the reason for using a difference in occurrence not a difference in number;

FIG. 14 is an example of a grouping code file;

FIG. 15 is an explanatory view of a grouping process;

FIG. 16 is an example of a hardware configuration of the computer capable of realizing the automatic grouping code generating system according to each embodiment; and

FIG. 17 is an explanatory view of a process of collecting object text.

### DESCRIPTION OF EMBODIMENTS

The best modes of carrying out the embodiments of the present invention are described below in detail with reference to the attached drawings.

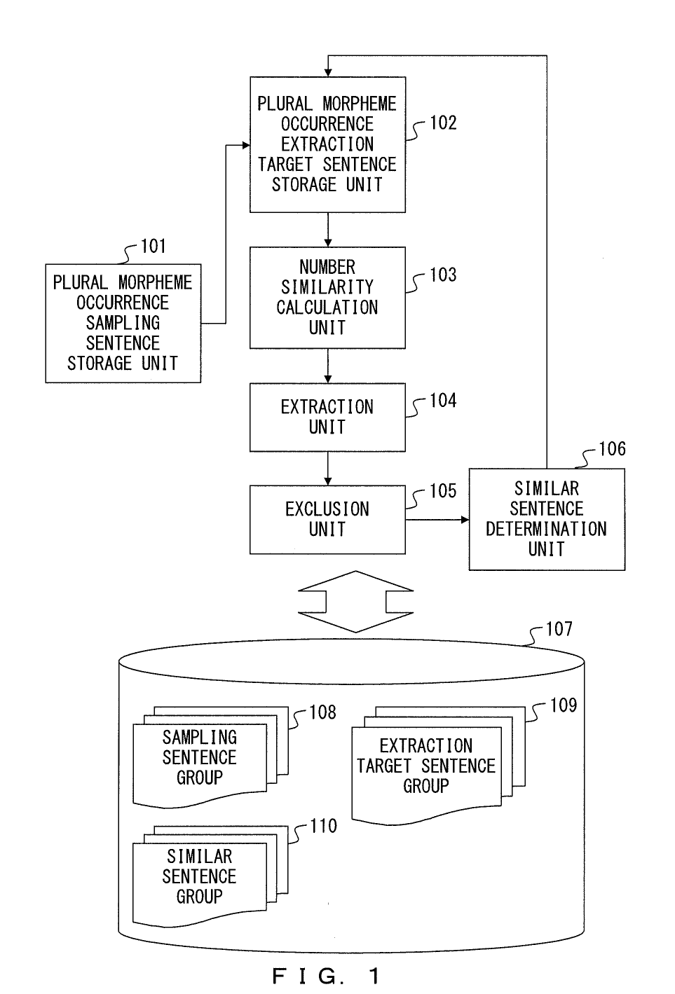

FIG. 1 is a configuration according to the first embodiment of the present invention.

A plural morpheme occurrence sampling sentence storage unit 101 associates a plurality of sampling sentence groups 108 identified by sentence identifiers with each of a plurality of morphemes commonly occurring in the sentences of the plurality of sampling sentence groups 108 with sentence identifiers, and stores the sampling sentence groups 108 in a storage unit 107. The sampling sentence groups 108 are determined by a user based on, for example, a similar sentence group 110 extracted when previously extracting a similar sentence.

A plural morpheme occurrence extraction target sentence storage unit 102 associates for each of a plurality of morphemes a plurality of extraction target sentence groups 109 identified by sentence identifiers with identifiers of sentences commonly occurring after extracting the identifiers of the sentences, and stores the sentences in the storage unit 107.

A number similarity calculation unit 103 calculates for each of the plurality of morphemes the similarity between the number of sentence identifiers of the sampling sentence groups 108 associated with the plurality of morphemes and stored in the storage unit 107 and the number of sentence identifiers of the extraction target sentence groups 109.

An extraction unit 104 extracts the sentence identifiers of the extraction target sentence groups 109 associated with the plurality of morphemes and stored in the storage unit 107 in a descending order of the calculated similarity.

An exclusion unit 105 excludes the sentence groups corresponding to the sentence identifiers other than the extracted sentence identifiers from the extraction target sentence groups 109.

A similar sentence determination unit 106 repeats each process of the plural morpheme occurrence sampling sentence storage unit 102, the number similarity calculation unit 103, the extraction unit 104, and the exclusion unit 105 until the difference between the number of sentence identifiers extracted by the extraction unit 104 and the number of sentence identifiers extracted immediately before by the extraction unit 104 reaches a predetermined value, and determines the extraction target sentence groups 109 identified by remaining sentence identifiers as the similar sentence groups 110 of the sampling sentence groups 108.

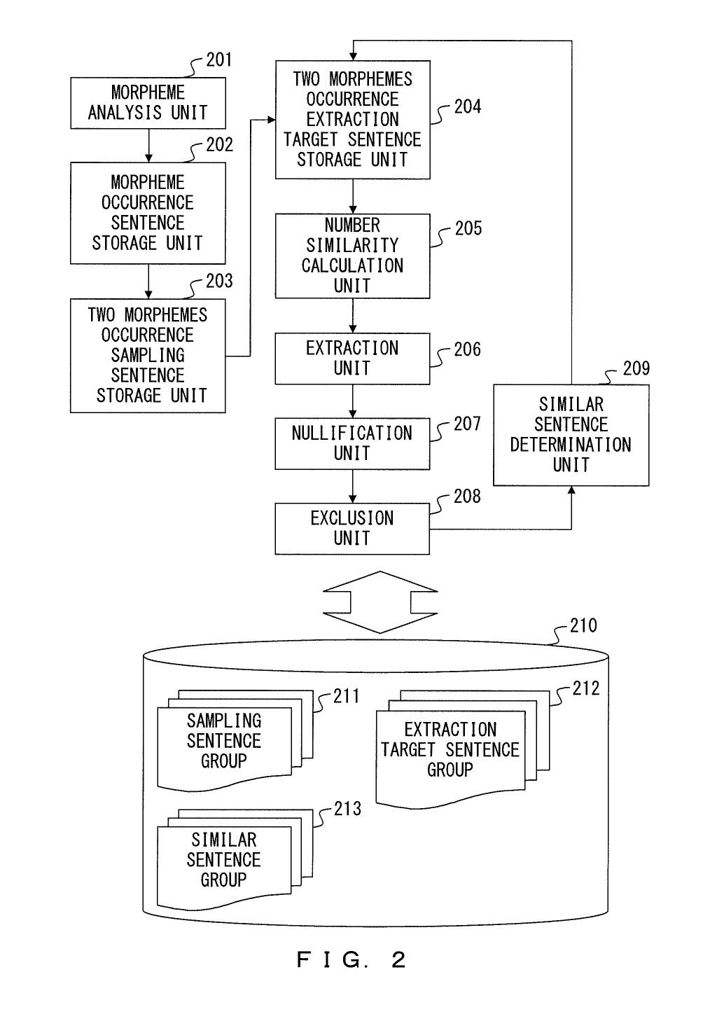

FIG. 2 is a configuration according to the second embodiment of the present invention.

A morpheme analysis unit 201 morpheme-analyzes a plurality of sampling sentence groups 211 and a plurality of extraction target sentence groups 212 stored in the storage unit 210 and identified by the respective sentence identifiers. The sampling sentence group 211 is determined by a user based on a similar sentence group 213 described later and extracted when previously extracting similar sentences.

A morpheme occurrence sentence storage unit 202 associates a morpheme, a sentence identifier in which the morpheme occurs, and the sampling sentence group 211 and the extraction target sentence group 212 based on a morpheme analysis result, and stores them in the storage unit 210.

A two morphemes occurrence sampling sentence storage unit 203 extracts morphemes stored in the storage unit 210 after associating them with the sentence identifiers of the plurality of sampling sentence groups 211, and associates every two morphemes with sentence identifiers and stores them in the storage unit 210.

A two morphemes occurrence extraction target sentence storage unit 204 extracts the sentence identifiers stored after associated with the two morphemes for every two morphemes in the extraction target sentence group 212 from the storage unit 210, and stores them in the storage unit 210 by associating them with two morphemes.

A number similarity calculation unit 205 calculates the similarity between the number of sentence identifiers of the sampling sentence group 211 stored in the storage unit 210 as associated with two morphemes and the number of sentence identifiers of the extraction target sentence group 212.

An extraction unit 206 extracts the sentence identifiers of the extraction target sentence group 212 stored in the storage unit 210 as associated with two morphemes without duplex extraction until all sentence identifiers of the sampling sentence group 211 are extracted in the descending order of similarity.

A nullification unit 207 defines two morphemes having no sentence identifiers without duplex extraction by the extraction unit 206 as no process targets.

An exclusion unit 208 excludes from the extraction target sentence group 212 the sentence group corresponding to the sentence identifiers other than the extracted sentence identifiers.

A similar sentence determination unit 209 repeats each process of the two morphemes occurrence extraction target sentence storage unit 204, the number similarity calculation unit 205, the extraction unit 206, and the exclusion unit 208 until a predetermined difference is reached between the number of sentence identifiers extracted by the extraction unit 206 and the number of sentence identifiers extracted by the extraction unit 206 immediately before, and the extraction target sentence group 212 identified by the remaining sentence identifiers is determined as the similar sentence group 213 of the sampling sentence group 211.

According to the first embodiment illustrated in FIG. 1 and the second embodiment illustrated in FIG. 2, an object sentence similar to the sampling sentence group can be efficiently extracted from the extraction target sentence group by repeating the process of narrowing a plurality of pairs of morphemes extracted from the sampling sentence group in the order of closer number of occurring sentences (higher similarity) to the extraction target sentence including each pair of morphemes.

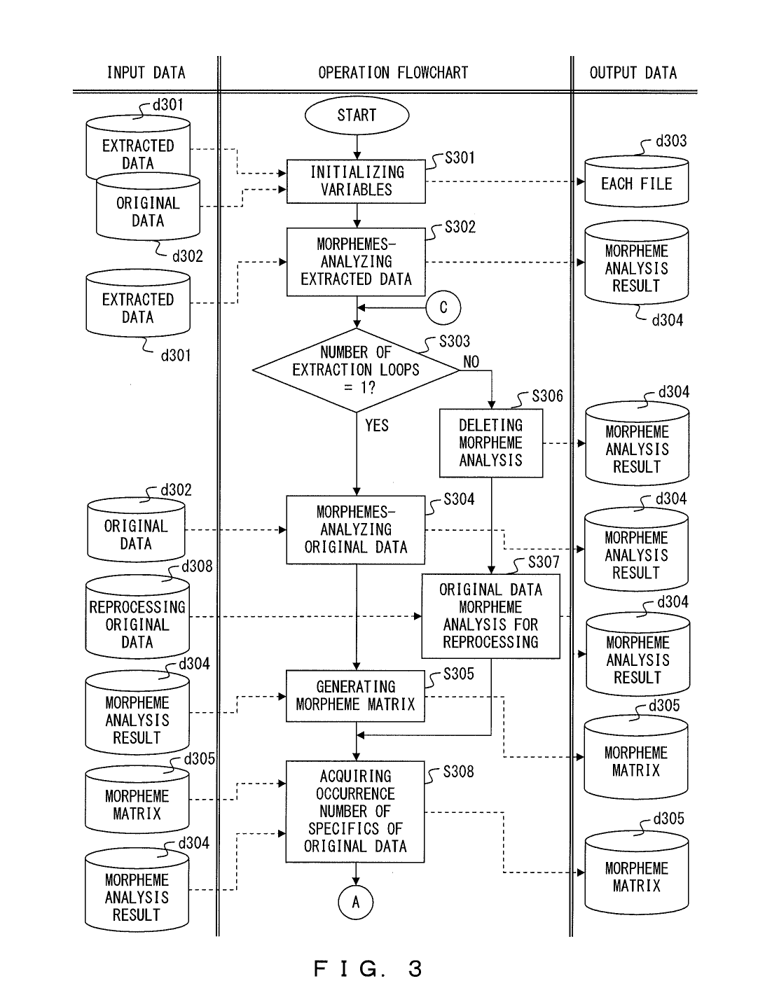

FIGS. 3 through 5 are flowcharts of the detailed operation with the configuration according to the second embodiment and input/output data.

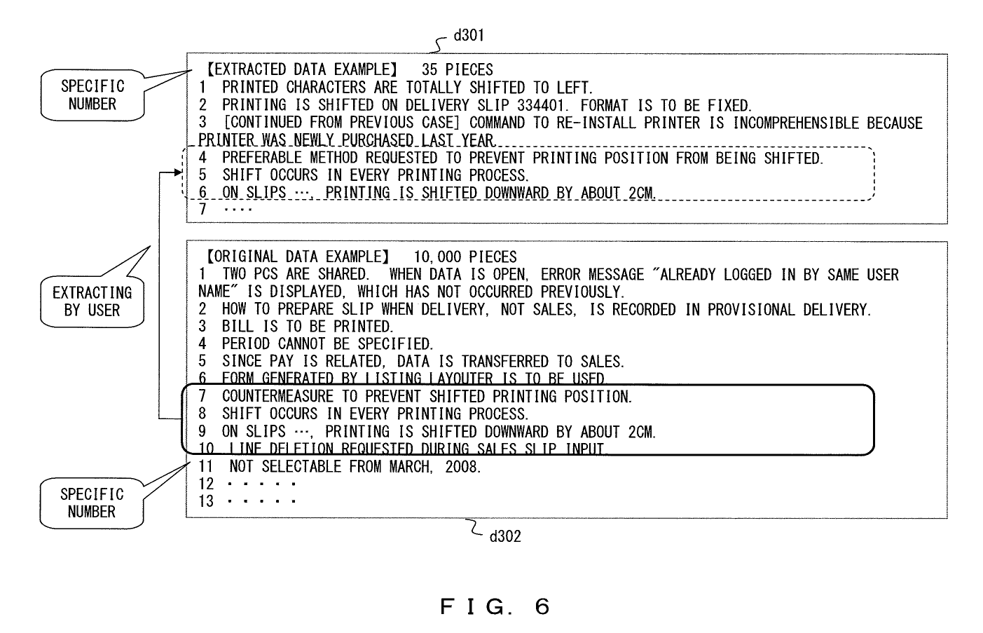

The detailed operations are sequentially described below with reference to the explanatory views and data structures illustrated in FIGS. 6 through 15.

First, in step S301, each file d303 of the morpheme analysis result, the morpheme matrix, the extraction details, the grouping code, and original data for reprocessing is deleted as initialization. In addition, the following variables are set.

The variable “number of extraction loops” is set to 1.

The variable “number of hits” is set to 0.

The number of specifics of the extracted data files is set in the variable “number of pieces of extracted data”.

The number of specifics of the original data file is set in the variable “number of pieces of original data”.

The extracted data file corresponds to the sampling sentence group 211 or 108 in FIG. 2 or 1 respectively. The extracted data file is, for example, a text data file such as an extracted data file d301 in FIG. 6, and indicates, for example, a grouping rule such as “abnormal printing”. The extracted data file is, for example, extracted and generated by a user from a original data file d302 illustrated in FIG. 6 which is a similar sentence group determined in the preceding extraction of a similar sentence. The original data file corresponds to the extraction target sentence group 212 or 109 illustrated in FIG. 2 or 1 respectively.

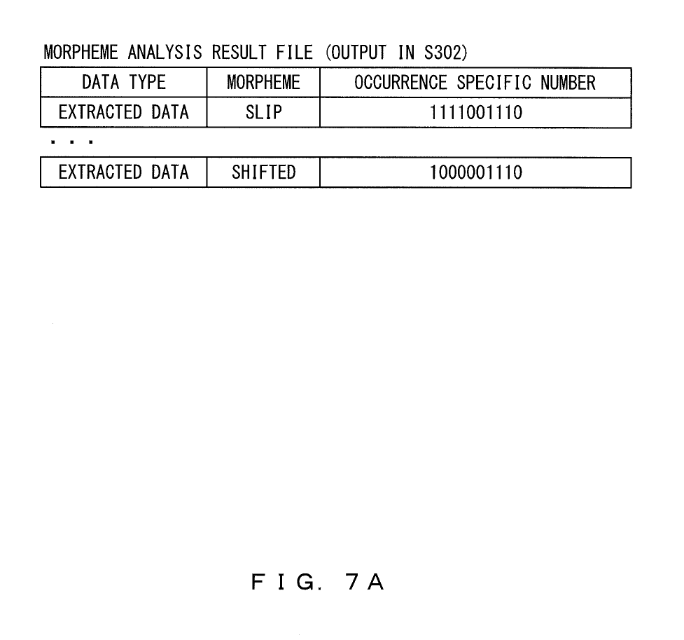

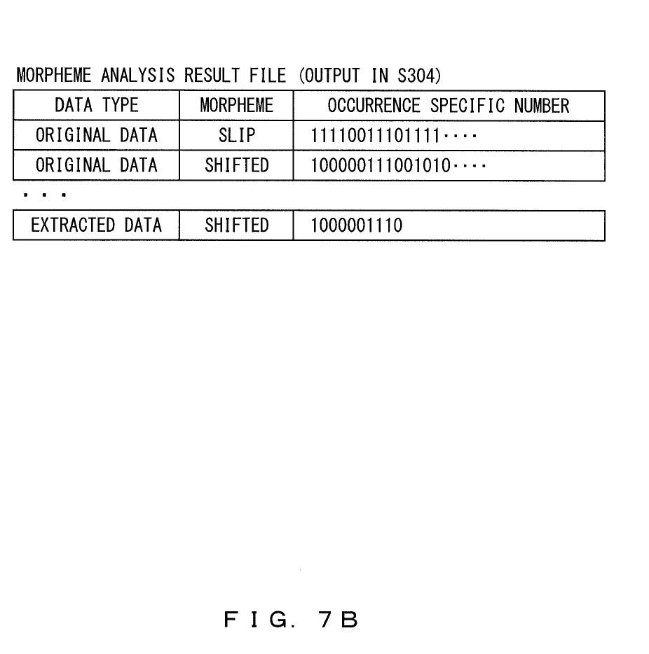

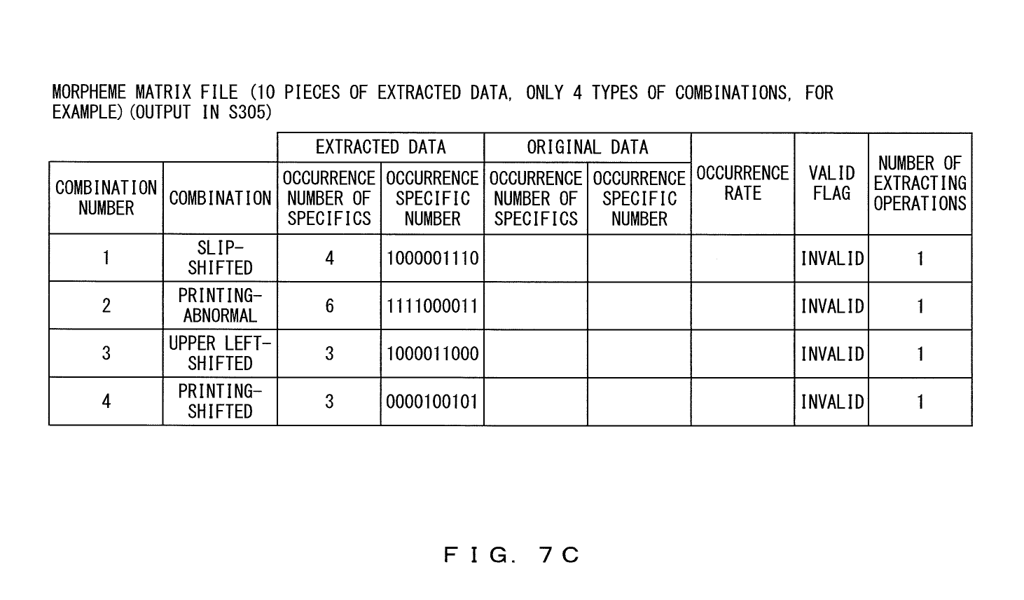

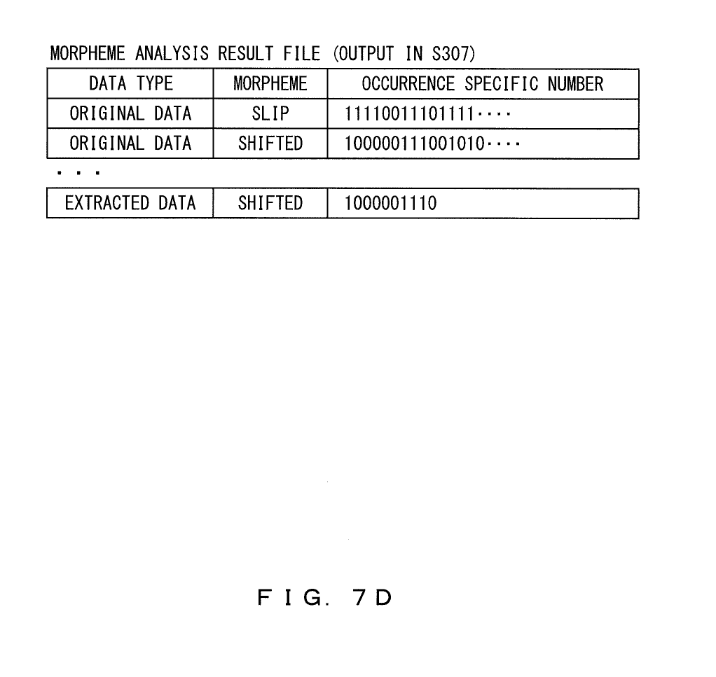

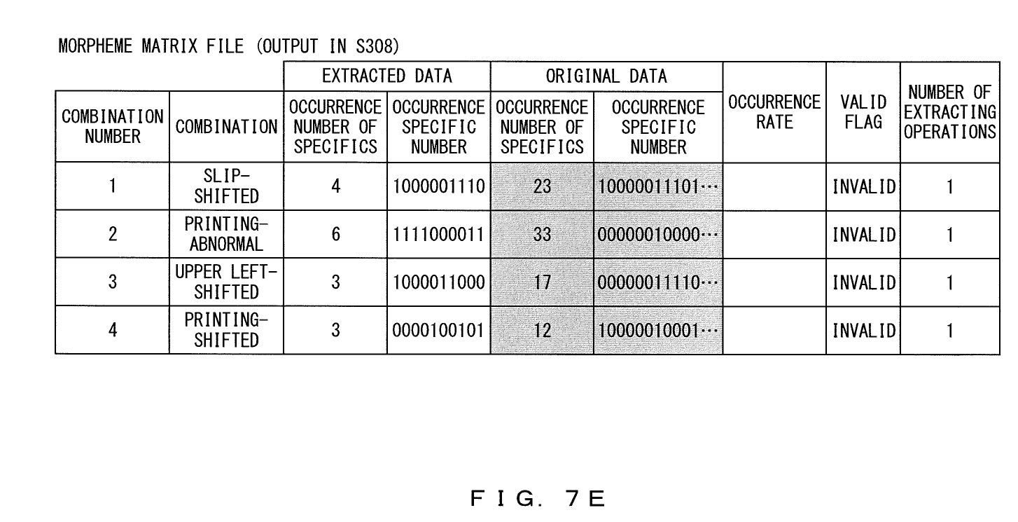

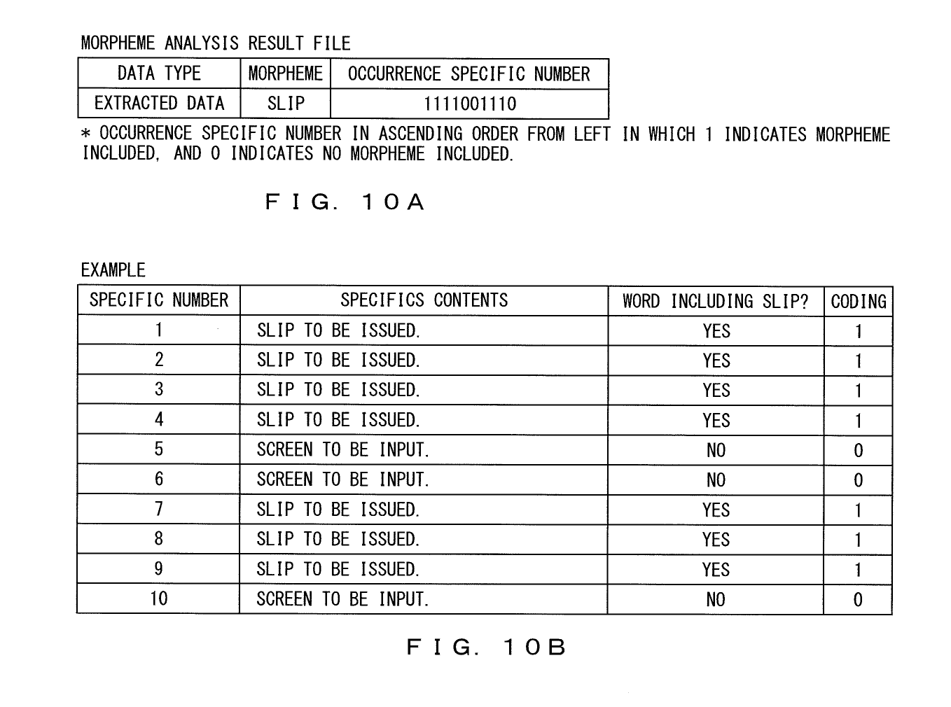

Next, in step S302 in FIG. 3, an extracted data file d301 is morpheme-analyzed, and the processing result is written to a morpheme analysis result file d304. The process corresponds to each process of the morpheme analysis unit 201 and the morpheme occurrence sentence storage unit 202 in FIG. 2. FIG. 7A is an example of a data configuration of the morpheme analysis result file d304 written in step S302 when the number of pieces of extracted data (=number of specifics of extracted data file) is ten (10). The “data type” item stores extracted data/original data. In step S302, a “data type” item stores “extracted data”. A “morpheme” item stores an analyzed morpheme. An “occurrence specific number” item stores 1 when the specifics of a specific number include the morpheme of a “morpheme” item, and 0 when they don't in the ascending order of each specific number (FIG. 6) in the extracted data file d301 from the left side. That is, in FIG. 10A and 10B indicate the relationship.

Next, in step S303 in FIG. 3, it is determined whether or not the number of extraction loops is 1. When the number of extraction loops is 1, the processes in steps S304 and S305 in FIG. 3 are performed. When the number of extraction loops is larger than 1, the processes in steps S306 and S307 in FIG. 3 are performed.

In step S304 in FIG. 3, the original data file d302 (FIG. 6) is morpheme-analyzed, and the processing result is written to the morpheme analysis result file d304. The process corresponds to each process of the morpheme analysis unit 201 and the morpheme occurrence sentence storage unit 202 in FIG. 2. FIG. 7B is an example of a data configuration of the morpheme analysis result file d304 written in step S304. In step S304, the “data type” item stores “original data”.

In the next step S305 in FIG. 3, the morpheme analysis result file d304 is read, a morpheme matrix as a combination of two morphemes is generated based on the entry having “extracted data” in the “data type” item, and the processing result is written in a morpheme matrix file d305. This process corresponds to the process of the two morphemes occurrence sampling sentence storage unit 203 in FIG. 2 or the process of the plural morpheme occurrence sampling sentence storage unit 101 in FIG. 1. FIG. 7C is an example of a data configuration of the morpheme matrix file d305 generated in step S305. The “combination number” item stores the number identifying the combination of each morpheme. The “combination” item stores a pair of morphemes. The “extracted data/occurrence number of specifics” item stores the number of specifics in the extracted data file d301 including two morphemes stored in the “combination” item. The “extracted data/occurrence number of specifics” item stores 1 when the specifics of a specific number include the two morpheme, and 0 when they don't in the ascending order of each specific number (FIG. 6) in the extracted data file d301 from the left side. The occurrence number of specifics can be obtained as each AND value for each bit position of each “occurrence specific number” of two entries corresponding to the two morphemes in the entries in which the “data type” item in the morpheme analysis result file d304 is “extracted data”. The occurrence specific number can be obtained as a total number the AND values of 1. In the morpheme matrix file d305, each item of “original data/occurrence number of specifics”, “original data/occurrence specific number”, and “occurrence rate” is blank. The items are described later. The “valid flag” item stores “invalid”. The “number of extracting operations” item stores “1”.

The processes in steps 5306 and S307 performed when the number of extraction loops is larger than 1 are described later.

Then, in step S308 in FIG. 3, an entry group having the value of the “number of extracting operations” item which is equal to the current number of extracting operations (current value is 1) indicated by the variable “number of extraction loops” , and the value of the “valid flag” item which is “invalid” is read from the morpheme matrix file d305. Then, for each two morphemes indicated by the “combination” item of each entry, the occurrence number of specifics and the occurrence specific number in the original data file d302 are acquired from the morpheme analysis result file d304. The occurrence number of specifics and the occurrence specific number are stored in the “original data/occurrence number of specifics” item and the “original data/occurrence specific number” item of each entry. This process corresponds to the process of the two morphemes occurrence extraction target sentence storage unit 204 in FIG. 2 or the plural morpheme occurrence extraction target sentence storage unit 102 in FIG. 1. To be concrete, the occurrence number of specifics can be obtained as each AND value for each bit position of each “occurrence specific number” of two entries corresponding to the two morphemes in the entries in which the “data type” item in the morpheme analysis result file d304 is “original data”. The occurrence specific number can be obtained as a total number the AND values of 1. FIG. 7E is an example of a data configuration of the morpheme matrix file d305 updated in step S308.

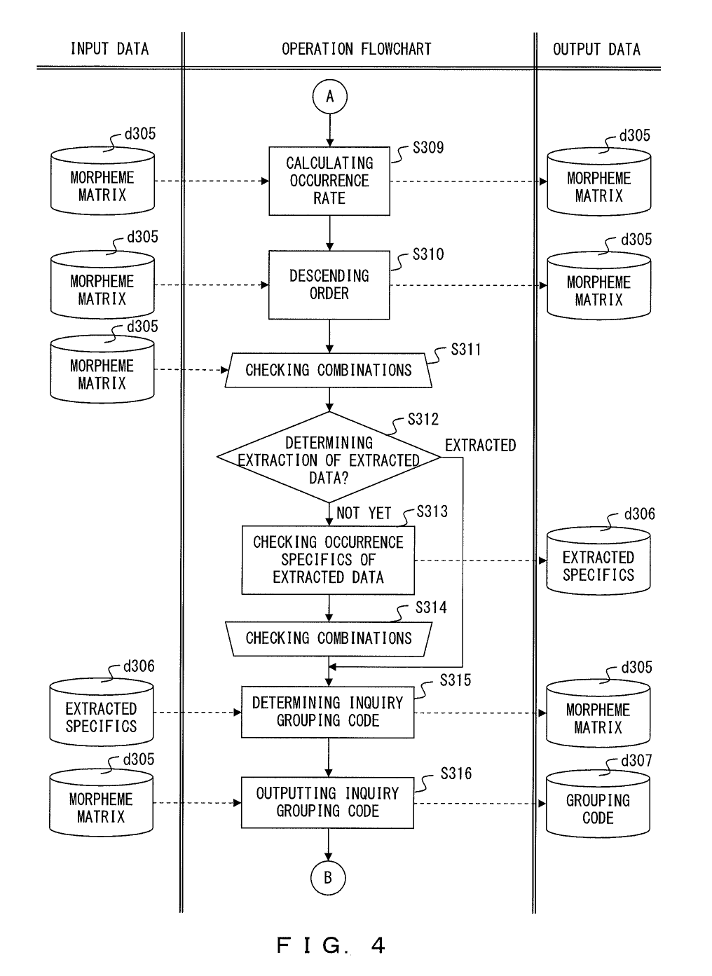

Next, in step S309 in FIG. 4, an entry group having the value of the “number of extracting operations” item which is equal to the current number of extracting operations (current value is 1) indicated by the variable “number of extraction loops” , and the value of the “valid flag” item which is “invalid” is read from the morpheme matrix file d305 . Then, for each entry, the occurrence rate is calculated by the following equation, and the result is stored in the “occurrence rate” item of each entry.

occurrence rate=“extracted data/occurrence number of specifics” item value÷“original data/occurrence number of specifics” item value

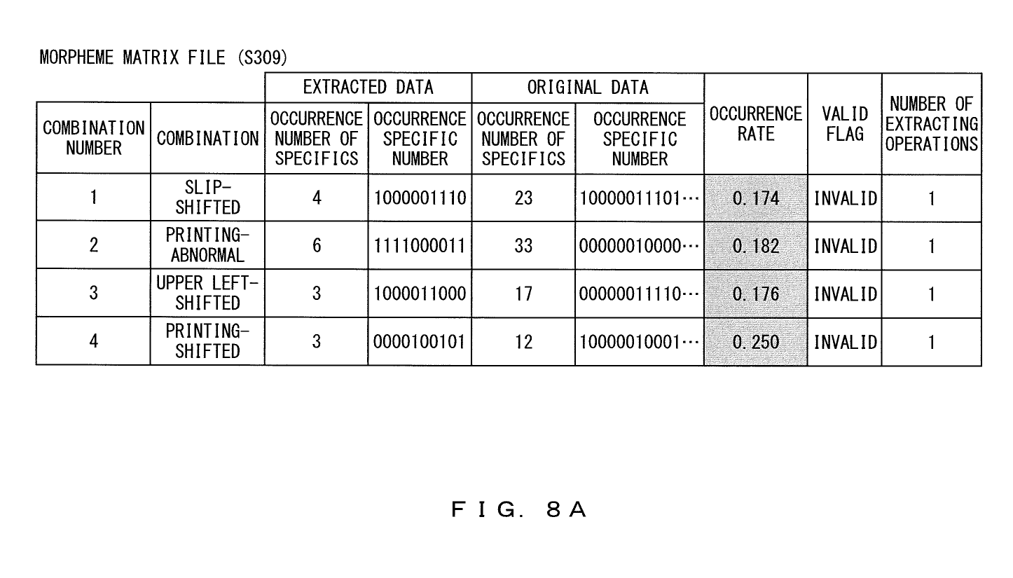

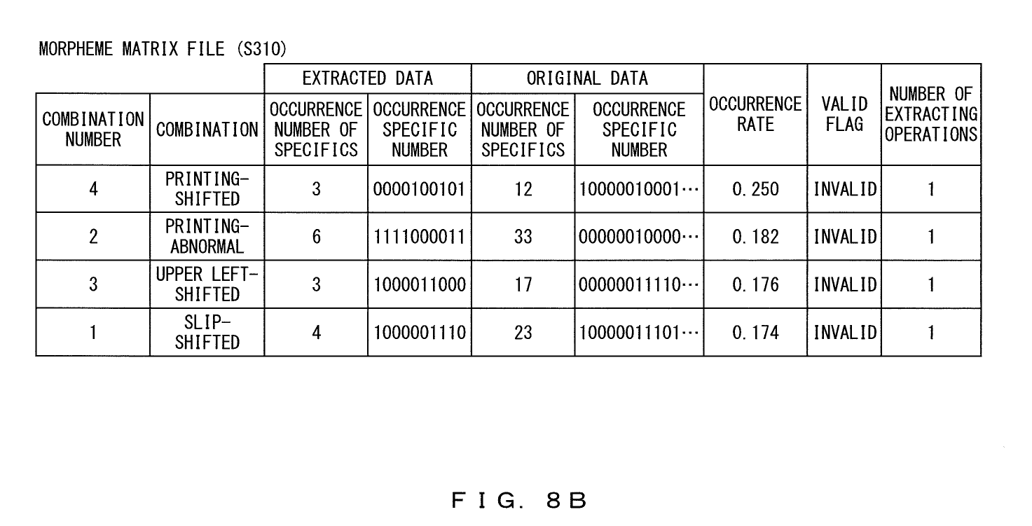

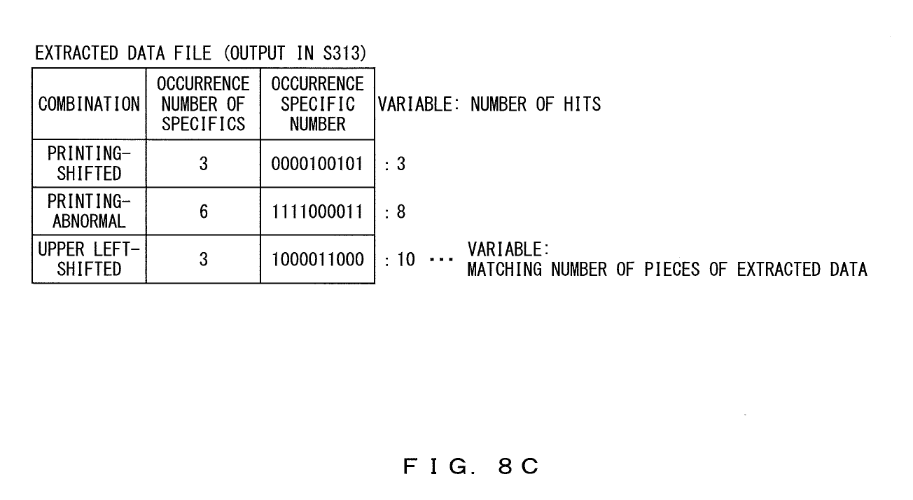

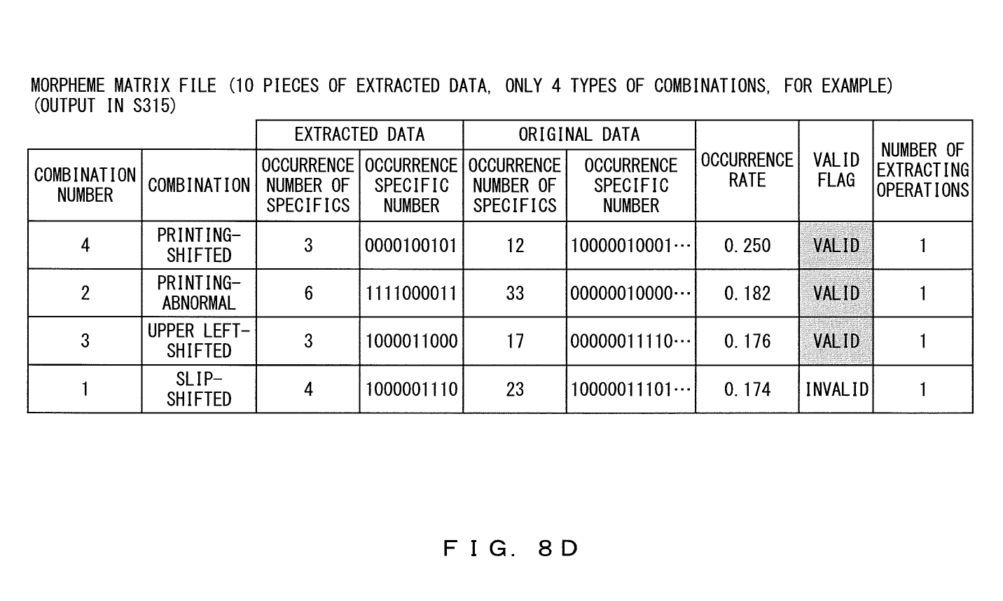

This process corresponds to the process of the number similarity calculation unit 205 or 103 in FIG. 2 or 1 respectively. FIG. 8A is an example of a data configuration of the morpheme matrix file d305 updated in step S308.

The lower the occurrence rate, the more the data other than the extracted data. On the other hand, the higher the occurrence rate, the less the data other than the extracted data. That is, the lower the occurrence rate, the more universal combination of the two morphemes in the original data, and the combination is not specific to extracted data. On the other hand, the higher the occurrence rate, the rarer combination of the two morphemes in the original data, and the combination is specific to extracted data. The data similar to extracted data can be more efficiently narrowed with the two morphemes occurring only in the original data closer to the extracted data than the two morphemes universally occurring (included in) the original data.

The combination of morphemes specific to the extracted data is not limited to the combinations that can be predicted by users. In addition, in the combination mechanically extracted based on the occurrence frequency in the extracted data, when it universally occurs also in the original data as described above, the data similar to the extracted data cannot be efficiently narrowed. By checking the similarity (level of the occurrence rate) in number between the extracted data and the original data in which the combinations of two morphemes occurrence, it can be determined whether or not the combination is specific to the extracted data.

Next, in step S310 in FIG. 4, the morpheme matrix file d305 is read, and an entry group having the value of the “number of extracting operations” item equal to the current number of extracting operations (the current value is 1) indicated by the variable “number of extraction loops”, and “invalid” as the value of the “valid flag” item is read. These entries are rearranged in the descending order of the occurrence rate. FIG. 8B is an example of a data configuration of the morpheme matrix file d305 rearranged in step S310.

Next, in step S311 in FIG. 4, the morpheme matrix file d305 is read, and an entry group having the value of the “number of extracting operations” item equal to the current number of extracting operations (the current value is 1) indicated by the variable “number of extraction loops”, and “invalid” as the value of the “valid flag” item is retrieved in the descending order of the value of the “occurrence rate” item, and each of the processes in steps 5312 and 5313 is sequentially performed on the retrieved entries as a loop process in steps 5311 through S314.

That is, in step S312 in FIG. 4, it is determined whether or not the variable “number of pieces of extracted data” matches the variable “number of hits”. If it is determined in step S312 that the number of hits has not reached the number of pieces of extracted data, the processes in steps S313 and S314 are performed. If it is determined in step S312 that the number of hits has reached the number of pieces of extracted data, the process in step S315 is performed.

In step S313, each value of the “combination” item, the “extracted data/occurrence number of specifics” item, the “extracted data/occurrence specific number” item is acquired from the entry retrieved in step S311, and the values are written to an extracted data file d306. FIG. 8C is an example of a data configuration of the extracted data file d306 stored in step S313. In this case, in the process of the entry having the largest value of “occurrence rate” item, the value of the “occurrence specific number” item is set in the variable “number of hits”. In the process of other entries, in each bit position of the “application specific number” item, 1 is added to the variable “number of hits” when the bit positions of the “application specific number” items of all entries in the extracted data file d306 stored before the above-mentioned entry are all 0, that is, only when it is the specific first occurring in this process. If all occurrence specific numbers of the retrieved combinations have been stored in the “application specific number” items in all entries of the extracted data file d306 which were stored before the entry, the entry is not stored in the extracted data file d306.

In step S314 in FIG. 4, the loop process is performed in step S312 on the entry next retrieved in step S311.

The series of processes in steps S310 through S314 correspond to the process of the extraction unit 206 in FIG. 2 or 1.

In step S315 in FIG. 4 after the above-mentioned extracting process, the extracted data file d306 is read, and each two-morpheme set of the “combination” item is retrieved. Then, in the morpheme matrix file d305, the value of the “combination” item matches the two-morpheme set, an entry in which the value of the “number of extracting operations” item matches the value of the variable “number of extraction loops” is retrieved, and the value of “valid flag” of the entry is updated to “valid”. The process corresponds to the process of the nullification unit 207 in FIG. 2. FIG. 8D is an example of a data configuration of the morpheme matrix file d305 updated in step S315.

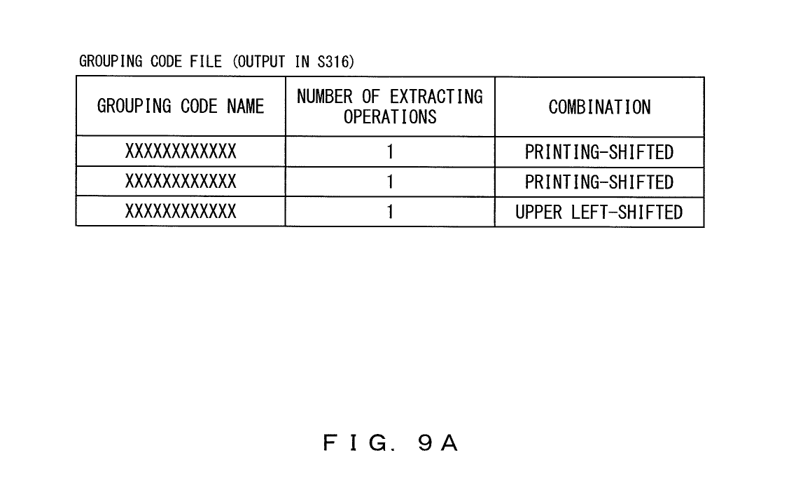

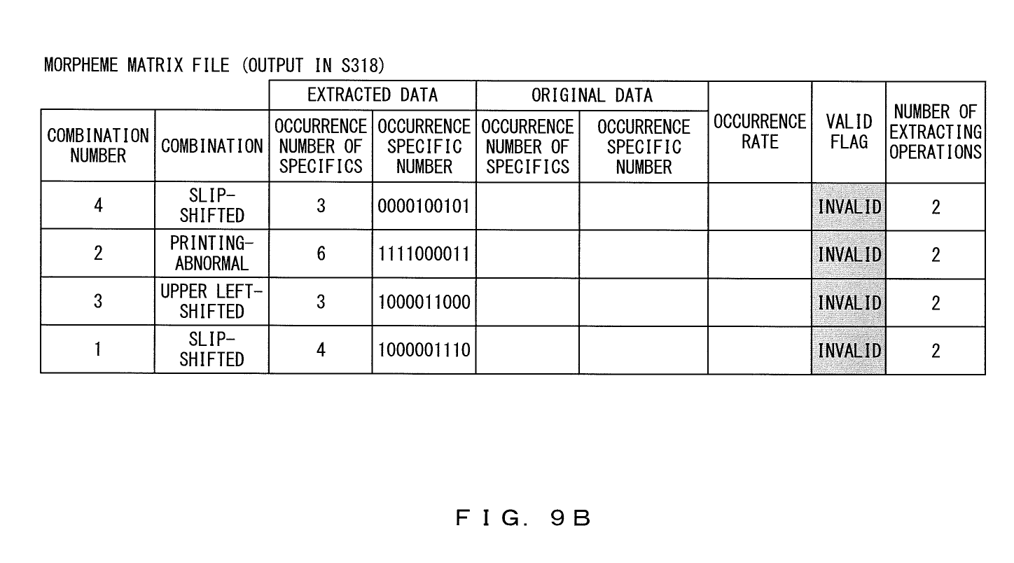

In the next step S316 in FIG. 4, an entry in which the value of the “number of extracting operations” item matches the variable “number of extraction loops” and the value of the “valid flag” item is “valid” is retrieved from the morpheme matrix file d305, and the two-morpheme set stored in the “combination” item of the entry is written to the grouping code file d307 with the arbitrary grouping code name and the current number of extraction loops. FIG. 9A is an example of a configuration of the grouping code file d307 written in step S316.

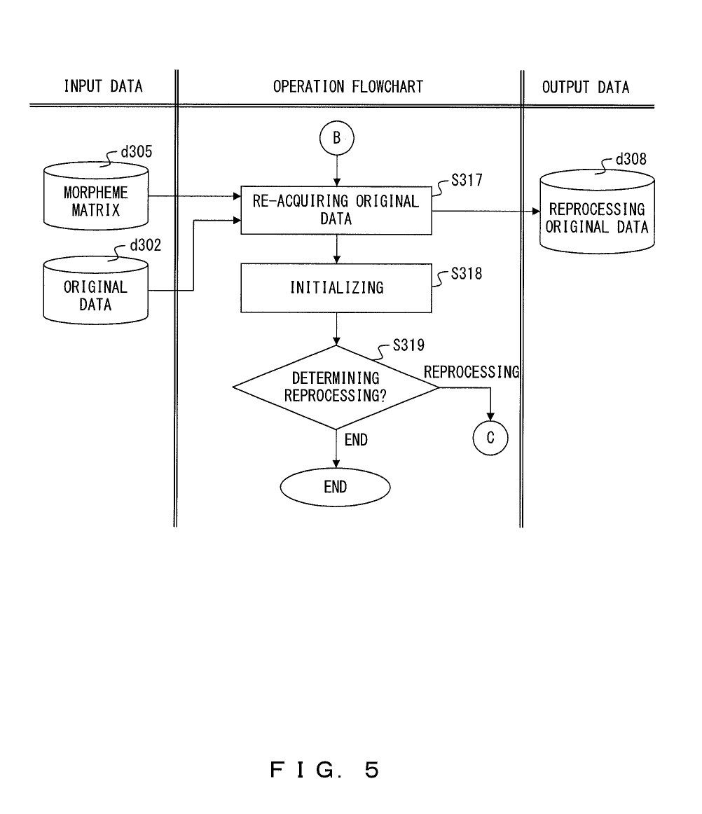

In step S317 in FIG. 5, en entry group in which the value of the “number of extracting operations” item matches the variable “number of extraction loops”, and the value of the “valid flag” item is “valid” is retrieved from the morpheme matrix file d305, and each occurrence specific number stored in the “original data/occurrence specific number” item of each retrieved entry is acquired. Then, based on these occurrence specific numbers, each of the specifics in the original data file d302 is read, and written to the reprocessing original data file d308. Then, the number of specifics stored in the reprocessing original data file d308 is set in the arrangement variable “number [N] of pieces of reprocessing original data”. The value of the variable “number of extraction loops” is set in “N”. That is, the number of pieces of reprocessing original data can be stored for each number of extraction loops in the arrangement variable “number [N] of pieces of reprocessing original data”. The process in step S317 corresponds to the process of the exclusion unit 208 or exclusion unit 105 in FIG. 2 or 1 respectively.

In step S318 in FIG. 5, +1 is added to the variable “number of extraction loops”. In addition, the variable “number of hits” is set to 0. Furthermore, in the morpheme matrix file d305, each item value of the “original data/occurrence number of specifics”, “original data/occurrence specific number”, and “occurrence rate” of each entry is cleared, “invalid” is set in the “valid flag” item, and the value of the incremented variable “number of extraction loops” is set in the “number of extracting operations”. FIG. 9B is an example of a data configuration of the morpheme matrix file d305 updated in step S318 when the first extraction loop is completed.

In step S319 in FIG. 5, when the value of the variable “number of extraction loops” is 2, reprocessing is determined, and control is passed to the process in step S303 in FIG. 3. When the value of the variable “number of extraction loops” is larger than 2, the following conditions are checked, and it is determined whether or not the reprocessing is to be performed.

1) The calculation is performed by “number of pieces of reprocessing original data in the current process±number of pieces of reprocessing original data in the preceding process”.

*number [N] of pieces of reprocessing original data÷number [N−1] of pieces of reprocessing original data

2) When the value obtained by the calculation 1) above is equal to or exceeds a threshold, the reprocessing is not performed, and the termination is determined.

3) When the value calculated in 1) above is lower than the threshold, the reprocessing is determined.

*The initial value of the threshold is 0.8, and can be varied.

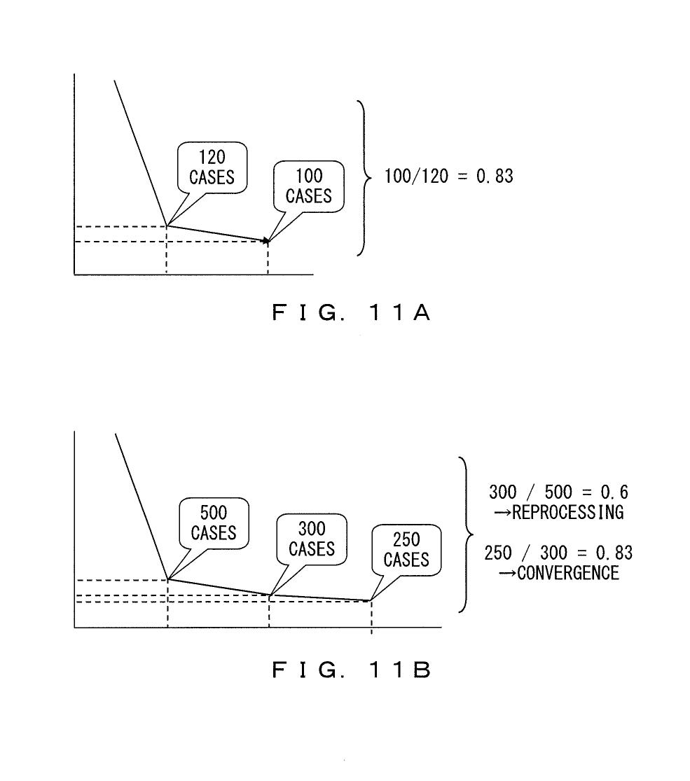

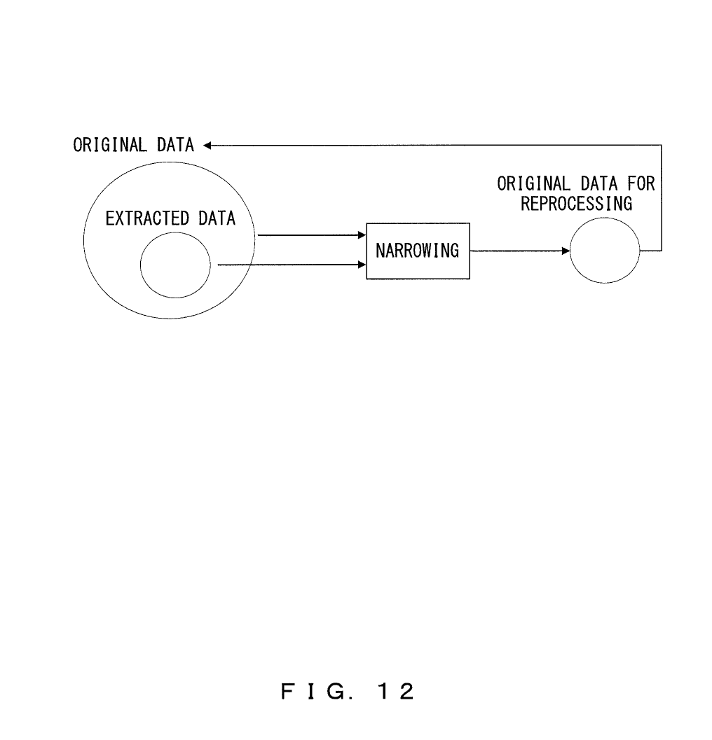

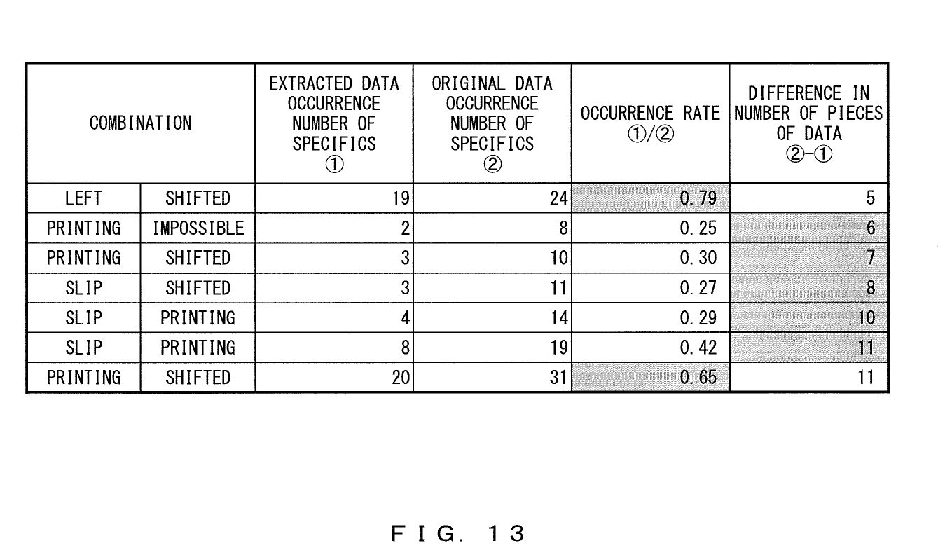

In step S317, relating to the reprocessing original data file d308 acquired as effectively including the morpheme of the extracted data file d301, when the rate of the data to the reprocessing original data file d308 obtained in the preceding process (the original data file d302 in the first process) is lower than a predetermined rate, the number of pieces of extracted data is considerably reduced as compared with the preceding process. On the other hand, when the rate of the data exceeds the predetermined rate, the rate of the extracted data does not indicate frequent changes as compared with the preceding process. In the former case, as illustrated in FIG. 12, it is considered that data effectively including only the morphemes of the extracted data file d301 can be obtained by performing the process of narrowing the sentence group again using the reprocessing original data file d308. For example, it is the case in which the rate in FIG. 11B is 0.6. On the other hand, in the latter case, it can be considered that the reprocessing original data file d308 has converged in the substantially optimum state. For example, it is the case in which the rate in FIG. 11A or 11B is 0.83.

Although two morphemes have low occurrence rates in the first process, higher occurrence rates can be acquired than those of two morphemes which first indicate high occurrence rates while narrowing the original data.

For example, assume (1) the case in which two morphemes occur in all of 10 pieces of extracted data, and in all of 100 pieces of original data, and (2) the case in which two morphemes occur in 3 pieces of 10 pieces of extracted data and in 20 pieces of 100 pieces of original data.

A) When there are 100 pieces of original data

occurrence rate of two morphemes of (1)=10÷100 =0.1

occurrence rate of two morphemes of (2)=3÷20=0.15

B) When original data is narrowed to 20 pieces in which the combinations of morphemes of (2) occur

occurrence rate of two morphemes of (1)=10÷20=0.5

occurrence rate of two morphemes of (2)=3÷20=0.15

The example above is a typical example indicating the process of a growing occurrence rate of universal two morphemes in the original data while narrowing the original data.

When the two morphemes frequently occurring in the extracted data also frequently occur in the original data as in the case (1) above, the entire original data is extracted even using the two morphemes, and the data cannot be narrowed to 20 pieces of data including the morphemes specific to the extracted data.

On the other hand, a morpheme occurring in many pieces of data can be regarded as a morpheme easily recognized by users. By repeating narrowing the original data, a combination of morphemes easily recognized by users can be presented as an extraction condition of the narrowed original data without the necessity of a user recognizing a specific morpheme to the extracted data used during the narrowing process.

The processes in steps S318 and S319 correspond to the processes of the similar sentence determination unit 209 or 106 in FIG. 2 or 1 respectively.

When the reprocessing is determined in step S319 in FIG. 5 as described above, control is returned to step S303 in FIG. 3, the determination is NO, and the processes in steps S306 and S307 are performed.

In step S306 in FIG. 3, all records having “original data” in the “data type” item in the morpheme analysis result file d304 are deleted.

In step S307 in FIG. 3, the reprocessing original data file d308 is morpheme-analyzed, and the processing result is written to the morpheme analysis result file d304. The process corresponds to each process of the morpheme analysis unit 201 and the morpheme occurrence sentence storage unit 202 in FIG. 2. The process is similar to the process in step S304 in FIG. 3 excluding that the reprocessing original data file d308 is used instead of the original data file d302. FIG. 7D is an example of a data configuration of the morpheme analysis result file d304 written in step S307. In step S307, the “data type” item stores “original data”.

In the following processes, as with the case in the first extracting operation, the processes in and after the process in step S308 in FIG. 3 are performed, and the narrowing process is performed by the two-morpheme set extracted from the extracted data file d301.

As a result of repeating the above-mentioned processes, when the termination is determined in step S319 in FIG. 5, the contents of the reprocessing original data file d308 obtained then are described s the similar sentence group 213 or 110 (object text) in FIG. 2 or 1.

In step S309 in FIG. 4 in the embodiment described above, it can be considered that the difference in number of pieces of data between the “extracted data/occurrence number of specifics” item value and the “original data/occurrence number of specifics” item value is used instead of the occurrence rate. However, as a result of the verification of actual data, a result that the occurrence rate is higher in grouping accuracy is obtained based on the following reasons.

(1) When the grouping code is determined by the difference in number of pieces of data, there occurs the problem that a combination in which the extracted data is successfully hit, and the original data is not frequently hit cannot be picked up in an upper process.

(2) Since the data cannot be picked up in the upper process, that is, there is an increasing number of combinations held with grouping codes, accuracy degradation is directly indicated.

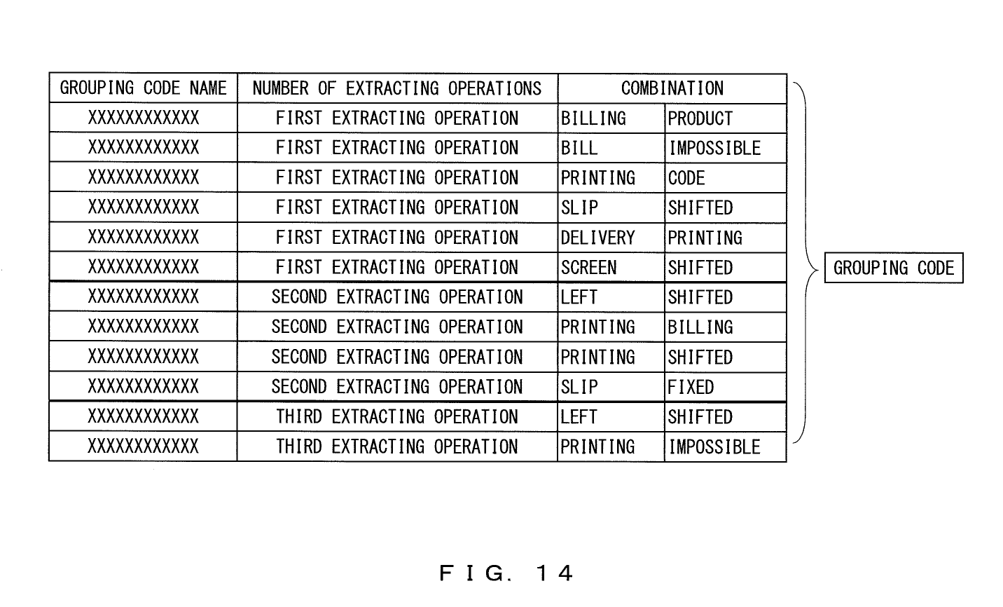

For example, in the case of the example in FIG. 13, when the combination of two morphemes of “left” and “shift” is presented, the result is that the extracted data and the original data are the closest with the maximum occurrence rate and the minimum difference in number of pieces of data, but in the case of the combination of two morphemes “print” and “shift”, the occurrence rate is high, and the extracted data and the original data are the second closest. However, the difference in number of pieces of data is large and the result that the extracted data and the original data are not close to each other. In the verification with actual data, the occurrence rate indicates a correct value.

Therefore, in step S309, the occurrence rate, not the difference in number of pieces of data, is to be used.

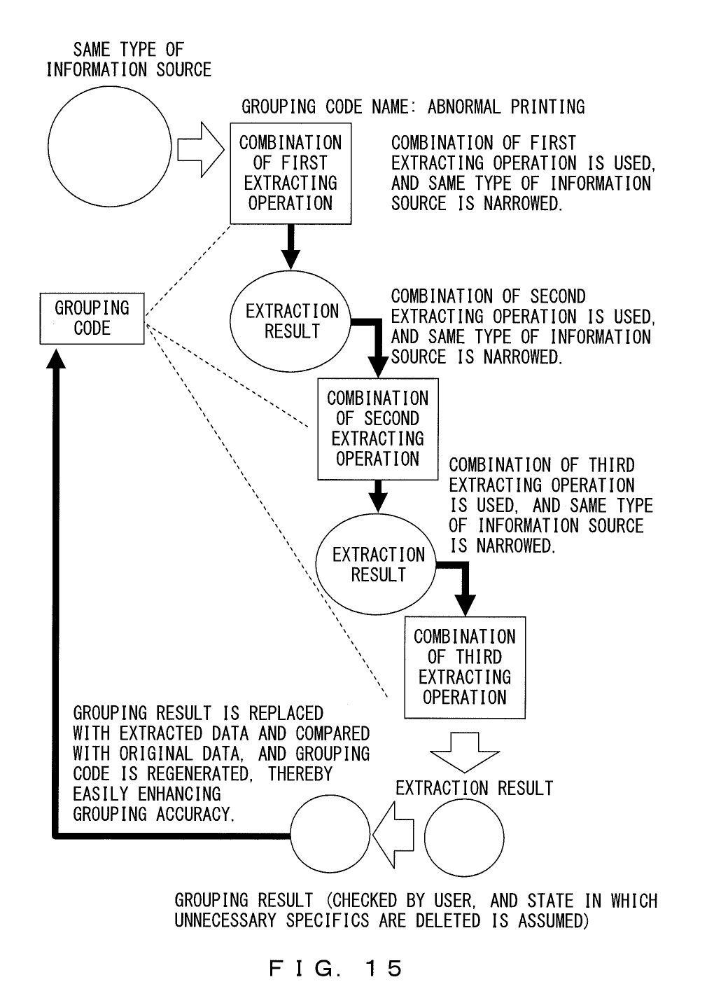

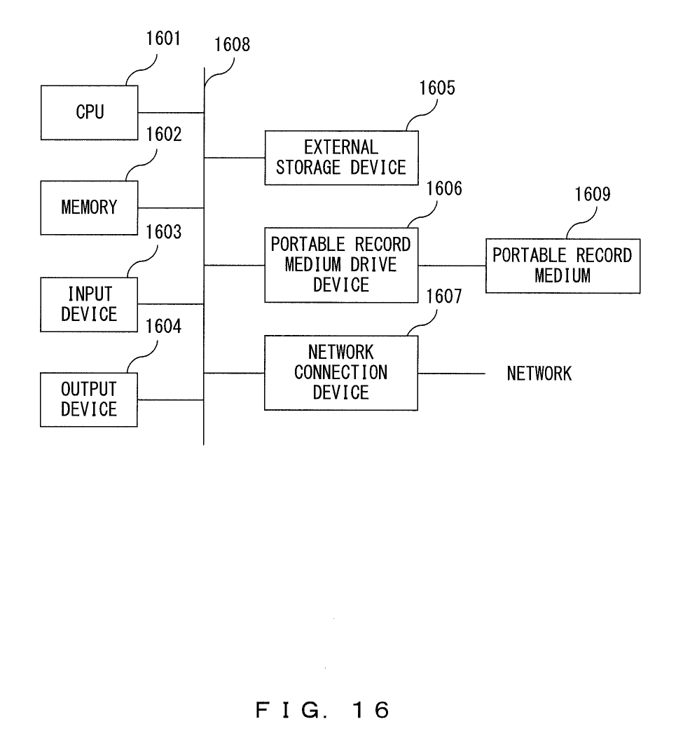

The grouping code file d307 obtained in step S316 in FIG. 4 can store the optimum combination of two morpheme in each extracting operation as illustrated in FIG. 14, for example. Thus, when the grouping code managed hierarchically is applied in grouping the same type of information source, the process illustrated in FIG. 15 can be performed. That is, first, the grouping code is retrieved in the first extracting operation from the grouping code file d307, and the narrowing process is performed using the grouping code of the first extracting operation for the same type of information source. Next, the grouping code is retrieved in the second extracting operation from the grouping code file d307, and the narrowing process is performed using the grouping code of the second extracting operation on the first extraction result. If the number of extracting operations is performed three times, the grouping code is retrieved in the third extracting operation from the grouping code file d307, and the narrowing process is further performed using the grouping code of the third extracting operation on the second extraction result. Then, the third extraction result is output as a final grouping result on which a check is performed by a user. The grouping result thus obtained is replaced with the extracted data, compared with the original data, and a grouping code is regenerated, thereby simply enhancing the grouping accuracy.

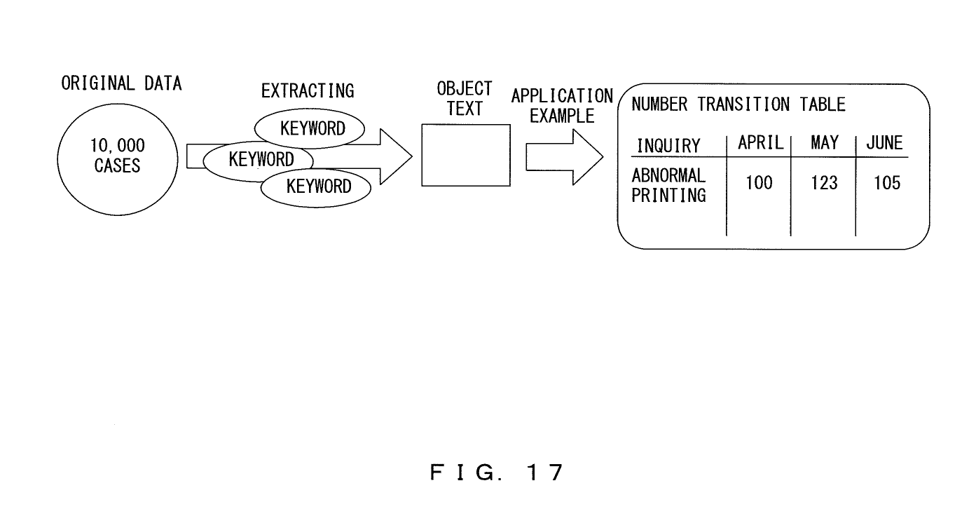

FIG. 16 is an example of a hardware configuration of the computer capable of realizing the automatic grouping code generating system according to each embodiment described above.

The computer illustrated in FIG. 16 includes a CPU 1601, memory 1602, an input device 1603, an output device 1604, an external storage device 1605, a portable record medium drive device 1606 to which a portable record medium 1609 is inserted, and a network connection device 1607, and they are interconnected through a bus 1608. The configuration illustrated in FIG. 16 is an example of a computer capable of realizing the above-mentioned system, and the computer is not limited to this configuration.

The CPU 1601 controls the entire computer. The memory 1602 is RAM etc. for temporarily storing a program or data stored in the external storage device 1605 (or the portable record medium 1609) when the program is executed or the data is updated. The CPU 1601 controls the entire system by reading the program to the memory 1602 and executing it.

The input device 1603 is configured by, for example, a keyboard, a mouse, etc. and their interface control devices. The input device 1603 detects an inputting operation with a keyboard, a mouse, etc. by a user, and notifies the CPU 1601 of the detection result.

The output device 1604 is configured by a display device, a printing device, and their interface control devices. The output device 1604 outputs data transmitted by the control of the CPU 1601 to a display device and a printing device.

The external storage device 1605 is, for example, a hard disk storage device, and mainly used in storing various data and programs.

The portable record medium drive device 1606 stores the portable record medium 1609 such as an optical disk, SDRAM, CompactFlash (registered trademark), etc., and has an auxiliary device for the external storage device 1605.

The network connection device 1607 connects a communication line of a LAN (local area network) or a WAN (wide area network).

The system of each embodiment is realized by the CPU 1601 executing the program loaded with the function of each block illustrated in FIG. 1 or 2, or the function corresponding to the process of the operation flowchart illustrated in FIGS. 3 through 5. The program can be distributed by, for example, storing in the external storage device 1605 and the portable record medium 1609, or can be acquired from a network by the network connection device 1607. In addition, the data used in each process is read to the memory 1602 from the external storage device 1605 and processed.

In the embodiments described with reference to FIGS. 2 and 3, a sentence narrowing process is performed by a two-morpheme set, but when a sentence narrowing process is performed by a set of a plurality of morphemes as illustrated in FIG. 1, the similar concept can be applied.

According to the present invention, object text can be extracted from an ungrouped text group without considering a keyword only by preparing a sample of an object text.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable record medium storing a sentence extracting program used to direct a computer to perform, comprising:
associating a plurality of sampling sentence groups identified by sentence identifiers with each of a plurality of morphemes commonly occurring in sentences of the plurality of sampling sentence groups with sentence identifiers;
storing the sampling sentence groups in a storage unit;
associating for each of a plurality of morphemes a plurality of extraction target sentence groups identified by sentence identifiers with identifiers of sentences commonly occurring after extracting the identifiers of the sentences;
storing the extraction target sentence groups in the storage unit;
calculating, for each of the plurality of morphemes, similarity between the number of sentence identifiers of the sampling sentence groups associated with the plurality of morphemes and stored in the storage unit and the number of sentence identifiers of the extraction target sentence groups;
extracting the sentence identifiers of the extraction target sentence groups associated with the plurality of morphemes and stored in the storage unit in a descending order of the calculated similarity;
excluding the sentence groups corresponding to the sentence identifiers other than the extracted sentence identifiers from the extraction target sentence groups;
repeating each the calculating, the extracting process, and the excluding process until the difference between the number of sentence identifiers extracted by the extracting process and the number of sentence identifiers extracted immediately before by the extracting process reaches a predetermined value; and
determining the extraction target sentence groups identified by remaining sentence identifiers as object sentence groups.

2. The record medium according to claim 1, wherein
the extracting process extracts the sentence identifiers of the extraction target sentence group stored in the storage unit as associated with the plurality of morphemes until all sentence identifiers of the sampling sentence group are extracted in the descending order of similarity.

3. The record medium according to claim 1, wherein:
the extracting process sequentially extracts the sentence identifiers of the extraction target sentence group stored in the storage unit as associated with the plurality of morphemes without duplex extraction until all sentence identifiers of the sampling sentence group are extracted in the descending order of similarity; and
defining plural morphemes having no sentence identifiers without duplex extraction by the extracting process as no process targets.

4. A non-transitory computer-readable record medium storing a sentence extracting program used to direct a computer to perform, comprising:
morpheme-analyzing a plurality of sampling sentence groups and a plurality of extraction target sentence groups stored in the storage unit and identified by respective sentence identifiers;
associating a morpheme, a sentence identifier in which the morpheme occurs, and the sampling sentence group and the extraction target sentence group based on the morpheme analysis result;
storing the morphemes in the storage unit;
extracting morphemes stored in the storage unit after associating them with the sentence identifiers of the plurality of sampling sentence groups;
associating the sampling sentence groups with sentence identifiers every two morphemes
storing the sampling sentence groups in the storage unit;
extracting the sentence identifiers stored after associated with the two morphemes for every two morphemes in the extraction target sentence group from the storage unit,
storing the extraction target sentence group in the storage unit by associating them with two morphemes;
calculating the similarity between the number of sentence identifiers of the sampling sentence group stored in the storage unit as associated with two morphemes and the number of sentence identifiers of the extraction target sentence group;
extracting the sentence identifiers of the extraction target sentence group stored in the storage unit as associated with two morphemes without duplex extraction until all sentence identifiers of the sampling sentence group are extracted in the descending order of similarity;
defining two morphemes having no sentence identifiers without duplex extraction by the extracting process as no process targets;
excluding the sentence groups corresponding to the sentence identifiers other than the extracted sentence identifiers from the extraction target sentence groups;
repeating each the calculating process, the extracting process, the defining process, and the excluding process until the difference between the number of sentence identifiers extracted by the extracting process and the number of sentence identifiers extracted immediately before by the extracting process reaches a predetermined value; and
determining the extraction target sentence groups identified by remaining sentence identifiers as object sentence groups.

5. The record medium according to claim 1, wherein
the sampling sentence group is determined by a user based on the similar sentence group extracted in the preceding similar sentence extracting process.

6. A sentence extracting method, comprising:
associating a plurality of sampling sentence groups identified by sentence identifiers with each of a plurality of morphemes commonly occurring in sentences of the plurality of sampling sentence groups with sentence identifiers;
storing the sampling sentence groups in a storage unit;
associating for each of a plurality of morphemes a plurality of extraction target sentence groups identified by sentence identifiers with identifiers of sentences commonly occurring after extracting the identifiers of the sentences;
storing the extraction target sentence groups in the storage unit;
calculating, for each of the plurality of morphemes, similarity between the number of sentence identifiers of the sampling sentence groups associated with the plurality of morphemes and stored in the storage unit and the number of sentence identifiers of the extraction target sentence groups;
extracting the sentence identifiers of the extraction target sentence groups associated with the plurality of morphemes and stored in the storage unit in a descending order of the calculated similarity;
excluding the sentence groups corresponding to the sentence identifiers other than the extracted sentence identifiers from the extraction target sentence groups;
repeating each the calculating process, the extracting process, and the excluding process until the difference between the number of sentence identifiers extracted by the extracting process and the number of sentence identifiers extracted immediately before by the extracting process reaches a predetermined value; and
determining the extraction target sentence groups identified by remaining sentence identifiers as object sentence groups.

7. A sentence extraction apparatus, comprising:
a plural morpheme occurrence sampling sentence storage unit to associate a plurality of sampling sentence groups identified by sentence identifiers with each of a plurality of morphemes commonly occurring in sentences of the plurality of sampling sentence groups with sentence identifiers, and to store the sampling sentence groups in a storage unit;
a plural morpheme occurrence extraction target sentence storage unit to associate for each of a plurality of morphemes a plurality of extraction target sentence groups identified by sentence identifiers with identifiers of sentences commonly occurring after extracting the identifiers of the sentences, and to store the sentences in the storage unit;
a number similarity calculation unit to calculate, for each of the plurality of morphemes, similarity between the number of sentence identifiers of the sampling sentence groups associated with the plurality of morphemes and stored in the storage unit and the number of sentence identifiers of the extraction target sentence groups;
an extraction unit to extract the sentence identifiers of the extraction target sentence groups associated with the plurality of morphemes and stored in the storage unit in a descending order of the calculated similarity;
an exclusion unit to exclude the sentence groups corresponding to the sentence identifiers other than the extracted sentence identifiers from the extraction target sentence groups; and
an object sentence determination unit to repeat each process of the plural morpheme occurrence extraction target sentence storage unit, the number similarity calculation unit, the extraction unit, and the exclusion unit until the difference between the number of sentence identifiers extracted by the extraction unit and the number of sentence identifiers extracted immediately before by the extraction unit reaches a predetermined value, and to determine the extraction target sentence groups identified by remaining sentence identifiers as object sentence groups.

8. A sentence extracting method, comprising:
morpheme-analyzing a plurality of sampling sentence groups and a plurality of extraction target sentence groups stored in the storage unit and identified by respective sentence identifiers;
associating a morpheme, a sentence identifier in which the morpheme occurs, and the sampling sentence group and the extraction target sentence group based on the morpheme analysis result,
storing the morphemes in the storage unit;
extracting morphemes stored in the storage unit after associating them with the sentence identifiers of the plurality of sampling sentence groups,
associating the sampling sentence groups with sentence identifiers every two morphemes
storing the sampling sentence groups in the storage unit;
extracting the sentence identifiers stored after associated with the two morphemes for every two morphemes in the extraction target sentence group from the storage unit, and storing them in the storage unit by associating them with two morphemes;
calculating the similarity between the number of sentence identifiers of the sampling sentence group stored in the storage unit as associated with two morphemes and the number of sentence identifiers of the extraction target sentence group;
extracting the sentence identifiers of the extraction target sentence group stored in the storage unit as associated with two morphemes without duplex extraction until all sentence identifiers of the sampling sentence group are extracted in the descending order of similarity;
defining two morphemes having no sentence identifiers without duplex extraction by the extracting procedure as no process targets;
excluding the sentence groups corresponding to the sentence identifiers other than the extracted sentence identifiers from the extraction target sentence groups;
repeating each the calculating process, the extracting process, the defining process, and the excluding process until the difference between the number of sentence identifiers extracted by the extracting process and the number of sentence identifiers extracted immediately before by the extracting process reaches a predetermined value; and
determining the extraction target sentence groups identified by remaining sentence identifiers as object sentence groups.

9. A sentence extraction apparatus, comprising:
a morpheme analysis unit to morpheme-analyze a plurality of sampling sentence groups and a plurality of extraction target sentence groups stored in the storage unit and identified by respective sentence identifiers;
a morpheme occurrence sentence storage unit to associate a morpheme, a sentence identifier in which the morpheme occurs, and the sampling sentence group and the extraction target sentence group based on the morpheme analysis result, and to store them in the storage unit;
a two morphemes occurrence sentence storage unit to extract morphemes stored in the storage unit after associating them with the sentence identifiers of the plurality of sampling sentence groups, and to associate every two morphemes with sentence identifiers and storing them in the storage unit;
a two morphemes occurrence extraction target sentence storage unit to extract the sentence identifiers stored after associated with the two morphemes for every two morphemes in the extraction target sentence group from the storage unit, and to store them in the storage unit by associating them with two morphemes;
a number similarity calculation unit to calculate the similarity between the number of sentence identifiers of the sampling sentence group stored in the storage unit as associated with two morphemes and the number of sentence identifiers of the extraction target sentence group;
an extraction unit to extract the sentence identifiers of the extraction target sentence group stored in the storage unit as associated with two morphemes without duplex extraction until all sentence identifiers of the sampling sentence group are extracted in the descending order of similarity;
a nullification unit to define two morphemes having no sentence identifiers without duplex extraction by the extracting unit as no process targets;
an exclusion unit to exclude the sentence groups corresponding to the sentence identifiers other than the extracted sentence identifiers from the extraction target sentence groups; and
an object sentence determination unit to repeat each process of the two morpheme occurrence extraction target sentence storage unit, the number similarity calculation unit, the extraction unit, and the exclusion unit until the difference between the number of sentence identifiers extracted by the extraction unit and the number of sentence identifiers extracted immediately before by the extraction unit reaches a predetermined value, and to determine the extraction target sentence groups identified by remaining sentence identifiers as object sentence groups.
